(19) United States
(12) Patent Application Publication
(10) Pub. No.: US 2024/0073096 A1
(43) Pub. Date: Feb. 29, 2024

(54) DESIGN METHOD FOR LIGHTWEIGHT WIRED MESH NETWORKING

(71) Applicant: ZHEJIANG LAB, Hangzhou (CN)

(72) Inventors: Peilei WANG, Hangzhou (CN); Wenjiao YANG, Hangzhou (CN); Wei LV, Hangzhou (CN); Xingming ZHANG, Hangzhou (CN)

(21) Appl. No.: 17/767,531

(22) PCT Filed: Nov. 10, 2021
(86) PCT No.: PCT/CN2021/129824

§ 371 Date: May 12, 2022

(30) Foreign Application Priority Data
Jun. 21, 2021 (CN) 202110682695.6

(51) Int. Cl. H04L 41/12; H04L 45/02

(52) U.S. Cl. CPC H04L 41/12; H04L 45/02

(57) ABSTRACT

The present disclosure discloses a design method for lightweight wired Mesh networking. The design method includes: designing a protocol format of a lightweight wired Mesh network message; designing an input parsing module of the lightweight wired Mesh network message; designing a heartbeat logic module between devices of the lightweight wired Mesh networking; designing a route management module of a lightweight wired Mesh network; designing a forwarding and processing module of the lightweight wired Mesh network message; and designing an underlying hardware interface management module.

### CROSS-REFERENCE TO RELATED APPLICATIONS

The present disclosure claims the benefit of priority to Chinese Application No. 202110682695.6 filed on Jun. 21, 2021 to China National Intellectual Property Administration and entitled “Design Method for Lightweight Wired Mesh Networking”, of which is incorporated herein by reference in this disclosure in its entirety.

### FIELD

The present disclosure relates to the technical field of a network communication technology, in particular to a design method for lightweight wired Mesh networking.

### BACKGROUND

In embedded application scenes such as the industrial Internet, a single local area network comprises a large number of devices such as sensors, controllers and actuators, and new requirements are provided for flexibility, robustness, cost and the like of networking. A traditional star-shaped networking mode with a router or a gateway as the center has obvious disadvantages in flexibility, robustness and cost, and the current Mesh networking has problems of complex development and maintenance, high cost and the like. The above problems limit the industrialization progress of emerging technologies such as industrial internet.

### SUMMARY

The present disclosure aims to provide a design method for lightweight wired Mesh networking to overcome shortcomings in the prior art.

In order to achieve the purpose, the present disclosure provides the following technical solution:
the present application discloses a design method for lightweight wired Mesh networking, wherein the lightweight wired Mesh networking consists of a plurality of devices, each device is provided with a plurality of ports used for receiving or transmitting lightweight wired Mesh messages, the devices are connected to one another through the ports, and the design method specifically comprises the following steps:
S1, designing a protocol format of a lightweight wired Mesh network message, wherein the lightweight wired Mesh network message comprises a message head and a message body;
S2, designing an input parsing module of the lightweight wired Mesh network message, wherein the input parsing module is used for inputting the received lightweight wired Mesh network message, acquiring a field of a message type in the message head of the lightweight wired Mesh network message, and calling a different manipulation function to process the lightweight wired Mesh network message according to the value of the field;
S3, designing a heartbeat logic module between the devices of the lightweight wired Mesh networking;
S4, designing a route management module of networks in the lightweight wired Mesh networking;
S5, designing a forwarding and processing module of the lightweight wired Mesh network message; and
S6, designing an underlying hardware interface management module.

Preferably, the specific design of step S1 is as follows: the length of the message head is 14 bytes, and the values of the first 6 bytes of the message head are all fixed 0xff; the 7th byte and the 8th byte of the message head are respectively high 8 bits and low 8 bits of target device ID; the 9th byte and the 10th byte of the message head are respectively high 8 bits and low 8 bits of the overall length of the lightweight wired Mesh network message; the 11th byte and the 12th byte of the message head are high 8 bits and low 8 bits of the maximum forwarding number of the lightweight wired Mesh network message; and the 13th byte and the 14th byte of the message head are high 8 bits and low 8 bits of the message type; and preferably, the message type in step S2 includes, but is not limited to, a heartbeat type network message, a route management type network message and a user service message, and the manipulation function includes, but is not limited to, a heartbeat type network message manipulation function, a route management type network message manipulation function and a service message manipulation function.

Preferably, step S3 specifically comprises the following substeps:
S31, designing a configuration interface, wherein the configuration interface is used for configuring heartbeat circulation time and a heartbeat time-out period;
S32, designing a transmitting and receiving mechanism of the heartbeat type network message, wherein transmitting and receiving of the heartbeat type network message is only maintained between devices directly connected by ports, and the devices indirectly connected by ports of an intermediate device do not receive the heartbeat type network message transmitted from each other; and
S33, designing a transmitting heartbeat time-out table and a receiving heartbeat time-out table, wherein the transmitting heartbeat time-out table is used for recording the time of transmitting the heartbeat type network message to the adjacent port last time, and if the time exceeds configured heartbeat circulation time, the heartbeat type network message needs to be transmitted again; and the receiving heartbeat time-out table is used for recording the time of receiving the heartbeat type network message of the adjacent port last time, and if the time exceeds the configured heartbeat time-out period, the device of the adjacent port is determined to be offline.

Preferably, a mode of designing a configuration interface in step S31 is one of the following modes:
S311, using a configuration file as an interface by a user;
S312, designing a special configuration interface and transmitting configuration data into the designed special configuration interface by the user; and
S313, defaulting that the heartbeat circulation time is 2 s, and the heartbeat time-out period is 1 min.

Preferably, step S4 specifically comprises the following substeps:
S41, designing a configuration interface, wherein the maximum number of devices in the current lightweight wired Mesh networking is selected, and the selection is one of four numbers of 128, 256, 512 and 1024;
S42, designing a hop table, relative to the target device ID, of the port, wherein the number of the hop tables is the same as the number of wired network ports of the devices, and the length of each hop table is equal to the maximum number of networking devices configured by the user; and the hop table is used for recording the hop, relative to each device, of each port;
S43, designing a second hop table, relative to the target device ID, of the device, wherein the second hop table is used for recording the minimum hop, relative to the target device, of the current device, and the length of the second hop table is equal to the maximum number of devices in the current networking configured by the user;
S44, designing a transmitting and receiving mechanism of the heartbeat type network message, wherein the route management type network message is only transmitted and received between the devices directly connected by the ports, and the devices indirectly connected by ports of an intermediate device do not receive the route management type network message transmitted from each other; and
S45, designing a reply and retransmission mechanism of the route management type network message, wherein the devices need to reply after receiving the route management type message; and if no reply is received after the devices transmit the route management type message, the devices periodically re-transmit the route management type message till the devices are determined to be offline or the ports are scanned to be not connected, and route information is updated.

Preferably, a mode of designing a configuration interface in step S41 is one of the following modes:
S411, using a configuration file as an interface by a user;
S412, designing a special configuration interface and transmitting configuration data into the designed special configuration interface by the user; and
S413, defaulting that the maximum number of devices is 256.

Preferably, step S5 specifically comprises the following steps:
S51, acquiring a field of the target device ID in the message head of the lightweight wired Mesh network message, and comparing the field of the target device ID to a field of an own device ID; and
S52, if the field of the target device ID is matched with the field of the own device ID, calling a service logic processing interface to process the lightweight wired Mesh network message; if the field of the target device ID is not matched with the field of the own device ID, searching the hop table according to the target device ID to obtain a port corresponding to the shortest hop, and forwarding the message from the port, wherein the service logic processing interface comprises a standard interface and a user defined interface;
S53, if obtaining of the port fails, updating route information, transmitting a route updating message to an adjacent port so as to recall a route table, and correcting route information of all ports in the lightweight wired Mesh networking.

Preferably, step S6 specifically comprises the following substeps:
step S61, designing a required hardware interface management module to provide a user with a registration function for a required hardware interface, wherein the required hardware interface comprises a hardware initialization interface, a message transmitting interface, a message receiving interface and a connection state query interface; and
step S62, designing an optional hardware interface management module to provide a user with a registration function for an optional hardware interface, wherein the optional hardware interface comprises a connection rate query interface, a hardware packet filtering configuration interface and a CRC verification configuration interface.

The present disclosure has the beneficial effects that: compared with the prior art, the present disclosure provides a design method for lightweight wired Mesh networking to solve the problems that an existing star-shaped network is not high in flexibility and robustness, and a networking mode such as wireless Mesh networking is high in cost and difficult in development and maintenance, the lightweight feature may be extremely highlighted in the present disclosure, the basic function is realized by the C language, about only 1K rows of codes are needed, the usage of memory data space is less than 5K during operation, and the lightweight wired Mesh networking may be transplanted in most common MCUs/FPGAs in the market. By the design method for the lightweight wired Mesh networking, two features that the Mesh networking is decentralized and all nodes are routes may be satisfied, the flexibility and robustness of the networking are greatly improved, and the design method for the lightweight wired Mesh networking has obvious advantages in scenes such as industrial redundant networking.

The features and advantages of the present disclosure will be described in detail by embodiments with reference to the accompanying drawings.

### BRIEF DESCRIPTION OF THE DRAWINGS

FIG. 1 is a flow diagram of a design method for lightweight wired Mesh networking according to an embodiment of the present disclosure.

FIG. 2 is a schematic diagram of a protocol format of a lightweight wired Mesh network message.

FIG. 3 is a structural design of the protocol format for implementing the lightweight wired Mesh network message by using the C language as a programming language.

FIG. 4 is a flow diagram of an input parsing module of the lightweight wired Mesh network message.

FIG. 5 is a networking structure diagram of lightweight wired Mesh networks.

FIG. 6 is a schematic diagram of a message structure of a route management type network message in design of the lightweight wired Mesh networking.

FIG. 7 is a flow diagram of processing and forwarding of a service logic message.

### DETAILED DESCRIPTION OF THE EMBODIMENTS

In order to make the objectives, technical solutions and advantages of the present disclosure more apparent, the present disclosure is further described in detail below with reference to the accompanying drawings and embodiments. However, it should be understood that the detailed description herein of specific embodiments is intended to illustrate the present disclosure and not to limit the scope of the present disclosure. Moreover, in the following description, description of well-known structures and techniques is omitted to avoid unnecessary confusion of the concepts of the present disclosure.

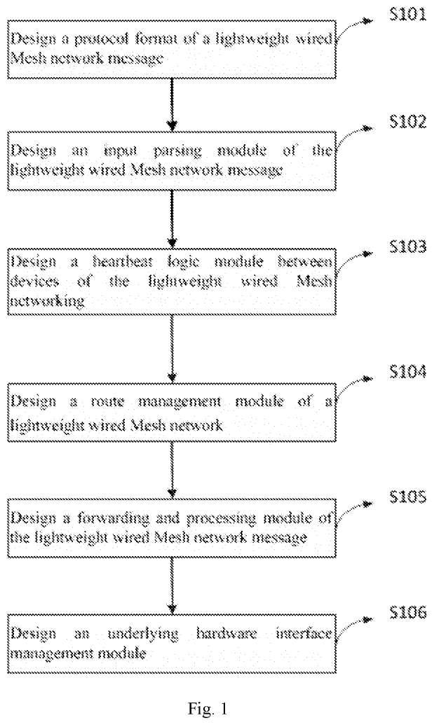

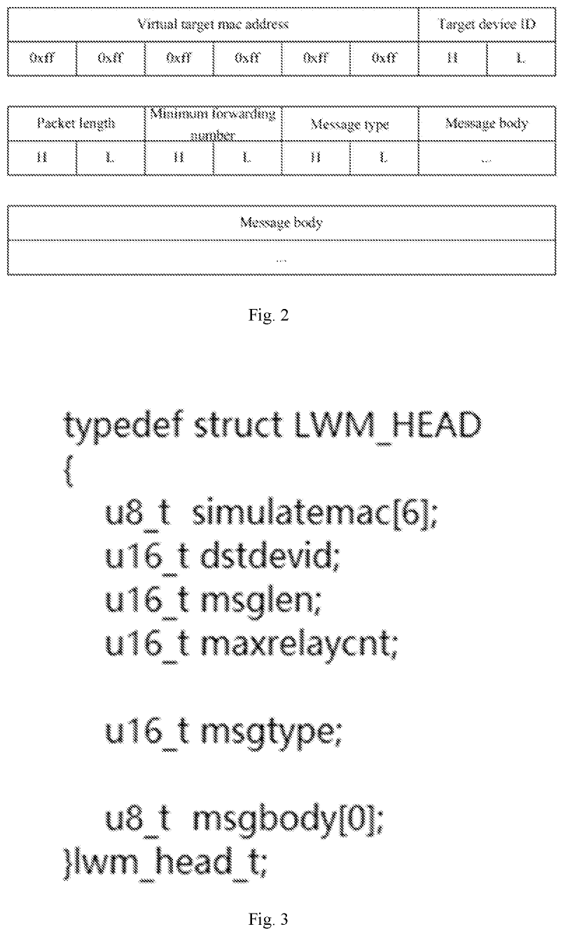

Referring to FIG. 1, an embodiment of the present disclosure provides a design method for lightweight wired Mesh networking, comprising:
step S1, a protocol format of a lightweight wired Mesh network message is designed:
specifically, referring to FIG. 2, the lightweight wired Mesh network message is divided into a message head and a message body, wherein the length of the message head is 14 bytes, values of the first 6 bytes of the message head are all fixed 0xff, because the drivers of the most underlying network port driver chips filter the MAC address by default, a message packet may be prevented from being filtered by adopting a broadcast address, the 7th byte and the 8th byte of the message head are respectively high 8 bits and low 8 bits of target device ID, and 16-bit device ID may support simultaneous networking of up to 65536 devices, the 9th byte and the 10th byte of the message head are respectively high 8 bits and low 8 bits of the overall length of the message packet, a single packet length of a common embedded network protocol stack is 1500 bytes, a 16-bit message length field may cover the identification requirements of the packet lengths, the 11th byte and the 12th byte of the message head are high 8 bits and low 8 bits of the maximum forwarding number of the message packet, the maximum forwarding number of the message packet is the same as the maximum number of devices of the current networking under the general condition, and therefore the length of the field is kept consistent with the length of the field of the target device ID, the 13th byte and the 14th byte of the message head are high 8 bits and low 8 bits of the message type, the realization of basic functions in the lightweight wired Mesh networking needs three types: heartbeat messages, route management messages and service messages, a user may expand the message types according to own service requirements, and a message body starts from the 15th byte of a network message packet.

The C language is used as a programming language to implement the present disclosure, and the message structure of a lightweight wired Mesh network message may be designed and defined in a form of a structural body with reference to FIG. 3.

According to a network message protocol, a traditional two-layer network message head is transformed, and 2-byte device ID is used for replacing a 6-byte mac address to serve as a device identifier, so that 4 bytes are saved to be used for identifying other information, and a foundation is laid for the lightweight characteristic of wired Mesh networking.

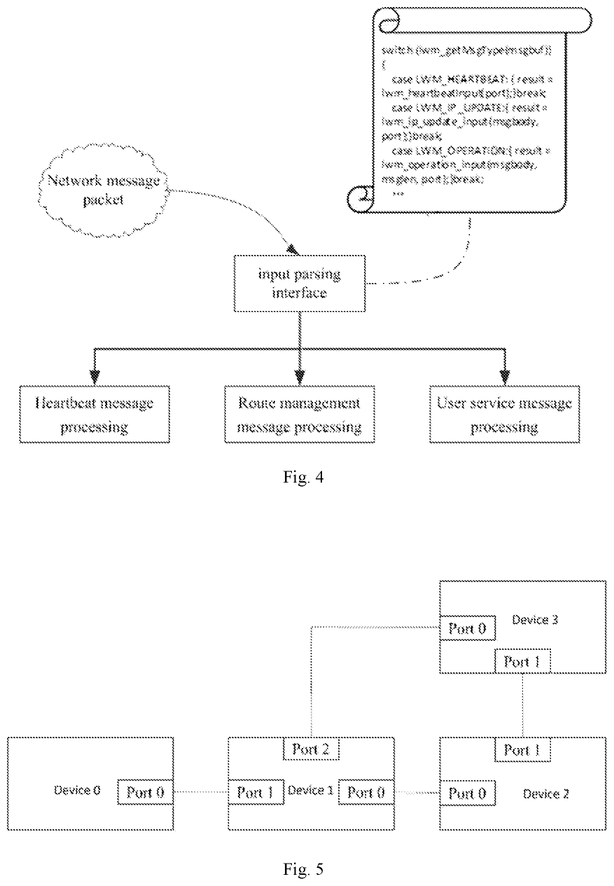

Step S2, an input parsing module of the lightweight wired Mesh network message is designed:
specifically, referring to FIG. 4, the input parsing module is used for inputting a received network message packet, acquiring a field of the message type in the message head of the lightweight wired Mesh network message, and calling a different manipulation function to process the message packet according to the value of the field.

The basic functions of the light wired Mesh networking are realized only by processing three types of messages, namely heartbeat type network messages, route management type network messages and user service messages, and correspondingly, the fields of message types in the message head are used for respectively calling a heartbeat type network message manipulation function, a route management type network message manipulation function, a service message manipulation function and the like. The C language is used as a programming language to implement the present disclosure, and it can be easily implemented by matching a switch-case statement with an enumeration variable of msg_type with reference to codes on the upper right portion of FIG. 4. If more than one service message of a user exists, the enumeration variable of msg_type may be expanded, and the expanded service logic manipulation function is correspondingly added to the switch-case statement of the data parsing module.

Step S3, a heartbeat logic module between lightweight wired Mesh networking devices is designed, and the step specifically comprises the following substeps:
step S31, a configuration interface is designed, and is used for configuring heartbeat circulation time and a heartbeat time-out period; specifically, a user may use a configuration file (such as a text file with the content of a j son format) as an interface, and may also design a special configuration interface and transmit configuration data into the special configuration interface, if the user does not configure the item, the default value of the heartbeat circulation time is 2 s, and the default value of the heartbeat time-out period is 1 min.

Step S32, a transmitting and receiving mechanism of the heartbeat type network message is designed, transmitting and receiving of the heartbeat type network message is only maintained between devices directly connected by ports, and devices indirectly connected by ports of an intermediate device do not receive the heartbeat type network message transmitted from each other; and specifically, referring to FIG. 5, a device 0 is directly connected to a device 1, the device 1 is directly connected to a device 2, and the device 0 only needs to maintain transmitting and receiving of heartbeat between the device 0 and the device 1. The device 0 does not receive heartbeat messages transmitted by the device 2, does not transmit heartbeat messages to the device 2, and does not need to judge whether the device 2 is online or not.

The C language is used as a programming language to implement the present disclosure, and when the heartbeat message is transmitted, the msgtype field as shown in FIG. 3 only needs to be filled, and is assigned as an enumeration value of the heartbeat message. The first 6 bytes of the message head are 6 0xffs by default so as to prevent a receiving end from filtering an MAC address. Other fields may not be filled, and are kept with default values. There is no difference between a destination address and a source address for the heartbeat message, and the heartbeat message is only bound with the ports, so that a heartbeat interaction mechanism is greatly simplified, and the lightweight feature of the present disclosure is further strengthened.

Step S33, two heartbeat time-out tables are designed, one is a transmitting heartbeat time-out table while the other one is a receiving heartbeat time-out table; the transmitting heartbeat time-out table is used for recording the time of transmitting the heartbeat type network message to the adjacent port last time, and if the time exceeds heartbeat circulation time set by the user, the heartbeat message needs to be transmitted again; and the receiving heartbeat time-out table is used for recording the time of receiving the heartbeat type network message of the adjacent port last time, and if the time exceeds the heartbeat time-out period set by the user, the device of the adjacent port is determined to be offline.

Specifically, the C language is used as a programming language to implement the present disclosure, the heartbeat time-out table may be implemented by an array, and the length of the array is equal to the number of wired network ports of the devices. Referring to FIG. 5, the device 1 is provided with two ports, the lengths of the receiving heartbeat time-out table and the transmitting heartbeat time-out table are both 2, and the receiving heartbeat time-out table and the transmitting heartbeat time-out table correspond to a port 0 and a port 1. Through interruption of a millisecond timer, each item in each heartbeat time-out table is added with 1 within every millisecond, and whether the current item is in a time-out state or not is judged. If the 0th item in the transmitting heartbeat time-out table of the device 1 is in a time-out state, a heartbeat transmitting interface in step S1032 needs to be called, the heartbeat message is transmitted from the port 0 of the device 1, and the item in the table is cleared after the message is transmitted. If the device 1 receives the heartbeat message from the port 0, the 0th item in the receiving heartbeat time-out table is cleared; if the heartbeat message is not received continuously, when the 0th item in the heartbeat time-out table is in a time-out state, the device 0 is determined to be offline, and then a series of offline logic manipulation functions, such as updating route information, are called.

Step S4, a route management module of lightweight wired Mesh networks is designed, the step specifically comprises the following substeps:
step S41, a configuration interface is designed, the maximum number of devices in the current lightweight wired Mesh networking is selected, and the selection range is four numbers of 128, 256, 512 and 1024; specifically, the user may use a configuration file (such as a text file with the content of a j son format) as an interface, and may also design a special configuration interface and transmit configuration data into the special configuration interface. If the user does not configure the item, the default value of the maximum number of devices in networking is 256; and the four numbers including 128, 256, 512 and 1024 are selected so as to maintain 4-byte alignment when in cooperation with the corresponding memory resources.

When the C language is used as a programming language to implement the present disclosure, the maximum number of devices selected by the user is transmitted into a code project as a compiling macro through a configuration file, after code compiling is completed, the use condition of code resources, such as the occupied ROM size and the occupied RAM size, may be obtained through a corresponding tool, and the use condition is used as a reference to compare the resources of the devices; and whether the devices can support the number set by the user or not is judged, and if the devices do not support the number set by the user, the number needs to be reduced.

Step S42, a hop table, relative to the target device ID, of port is designed, the number of the hop tables is equal to the number of wired network ports of the devices, and the length of each table is equal to the maximum number of networking devices configured by the user; the hop table is used for recording the hop, relative to each device, of each port, the hop, relative to the own device, of the port is 0, the hop, relative to the adjacent device directly connected to the port, is 1, and the hop is added with 1 when passing through one device; after the device is powered on, the hop, relative to the own device ID, of each port is initialized to be 0, and the hop, relative to other device IDs, is initialized to be the maximum number of devices in the current networking configured by the user; specifically, the C language is used as a programming language to implement the present disclosure, and a two-dimensional array hops[port][dstDevId] may be used as a hop table; referring to FIG. 5, assuming that the maximum number of devices configured by the user is 128, four devices are currently online, and the device 0 has only 1 port, so it is actually a one-dimensional array, and during initialization, the hop table of the device 0 has an initial value of hops[1][128]={0, 128, 128, . . . }; the first hop value in the array is 0 due to the fact that the value is the hop of the device 0 relative to itself; referring to FIG. 5, assuming that the maximum number of devices configured by the user is 128, four devices are currently online, the device 2 and the device 3 both have 2 ports, and during initialization, the initial value of the hop table of the device 2 is hops[2][128]={{128, 0, 128, 128, . . . }, {128, 0, 128, 128, . . . }}, the second hop value in the one-dimensional array corresponding to each port is 0 due to the fact that the value is the hop of the device 1 relative to itself, and the initial values of the hop tables of the device 1 and the device 3 can be analogized.

Step S43, a second hop table, relative to target device ID, of the device is designed, and is used for recording the minimum hop, relative to the target device, of the current device, the length of the second hop table is equal to the maximum number of devices in current networking configured by the user, and the minimum hop, relative to the target device, of the current device is equal to the minimum value of the hop, relative to the target device, of each port of the current device.

Specifically, the C language is used as a programming language to implement the present disclosure, and a one-dimensional array shortestHops[dstDevId] is used as a second hop table. The relation between the second hop table and the hop table in step S42 is as follows: shortestHops[dstDevId]=min{hops[0][dstDevId], hops[1][dstDevId], . . . }, namely, the minimum hop, relative to the target device, of the current device is equal to the minimum value in the hop, relative to the target device, of each port of the current device.

Step S44, a transmitting and receiving mechanism of a route management type network message is designed, the message body of the route management type network message comprises information of the minimum hop, relative to other devices in the current networking, of the device transmitting the message, and the device updates and synchronizes hops in the hop table and the second hop table by means of transmitting and receiving the route management type network message; and the route management type network message is only transmitted and received between devices connected directly, and the devices indirectly connected by ports of an intermediate device do not receive the route management type network message transmitted from each other.

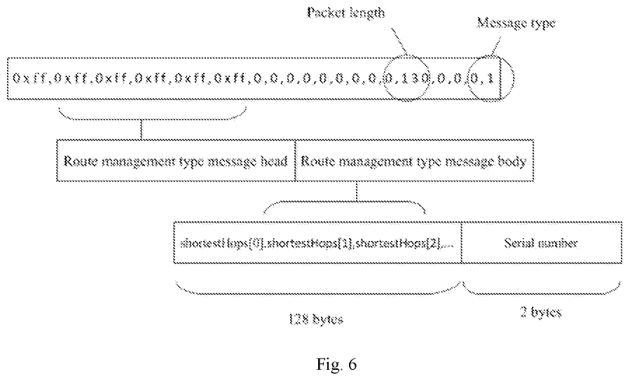

Specifically, referring to FIG. 6, the C language is used as a programming language to implement the present disclosure, and then a one-dimensional array shortestHops[128] described in step S1043 is directly copied into a message body. In order to guarantee freshness of the route management type network message, a serial number or a timestamp needs to be added at the tail of the message body, and a receiving side of the message may judge whether the route management type network message is the newest route management type network message or not through the serial number or timestamp.

According to the above description, after the user sets the maximum number of devices, the length of a route management type network message body is determined, and the maximum number of devices set by the user may be obtained by determining the length of the route management type network message. Therefore, even if the maximum numbers of devices configured for different devices by the user in the same networking are not consistent, the overall networking function may be compatible, and only certain devices may not be reached. For example, the maximum number of devices set on the device 0 is 128, and then a device 129 is unreachable even if the device 0 and the device 129 are connected by a physical circuit.

The device updates and synchronizes hops in the hop table and the second hop table by transmitting and receiving the route management type network message, specifically, referring to FIG. 5, assuming that the maximum number of devices configured by the user is 128, after power-on initialization of the device 0 is completed, the device 0 periodically scans a connection state of a port 0, and when the port 0 is found to be changed into the connection state from a connection-free state, the route management type network message is constructed and transmitted out from the port 0 of the device 0. After receiving the route management type network message from the port 0 of the device 1, the device 1 updates the array hops[3][128], because the message is received from the port 0 of the device 1, hops[0][128] is updated to {1, 0, 128, 128, . . . }, the first value is 1 due to the fact that the hop, relative to the device 0, of the port 0 of the device 1 is 1, and the second value is 0 due to the fact that the hop, relative to the device 1, of the port 0 of the device 1 is 0; and at the moment, the array shortestHops[128] of the device 1 is updated from {128, 0, 128, . . . } in an initialized state to {1, 0, 128, . . . }.

Four switches are used for triggering the route management type network message: 1) after the device is powered on, the states of various ports are connection-free states by default, the connection states of the various ports are circularly scanned after power-on initialization is completed, and when the state of the port is changed from the connection-free state to the connection state, the route management type network message is actively transmitted to the ports; 2) after the device receives the route management type network message transmitted by a certain port, and discovers that the table of shortestHops[maxDevNum] of the device is updated, the updated hop table is placed into the message body, and is transmitted out from other connected ports (the port receiving the message does not transmit the hop table to prevent looping), and thus, route information in the overall networking is updated and synchronized in a diffusion manner; 3) a heartbeat logic module described in step S3 detects that the device connected to a certain port is offline, the array hops[port][dstDevId] and the array shortestHops[dstDevId] of the device are updated, and the updated hop table is transmitted out from other connected ports; and 4) when the device detects broken routes, the route management type network message is actively transmitted out to enable other networking devices to synchronize route information, and a mode for detecting the broken routes is specifically described in step S5 hereinafter.

Referring FIG. 5, the device 0 is only directly connected with the device 1, therefore, the device 0 is only used for transmitting and receiving the route management type network message for the device 1, and interaction of route management type network messages does not exist between the device 0 and the device 2 or between the device 0 and the device 3.

In the conventional routing strategy, a large number of broadcast packets need to be transmitted for interaction, and various complex algorithms are needed to prevent looping from causing unlimited transmission of the broadcast packets, and in view of the transmitting and receiving mechanism of the route management type network message in the lightweight wired Mesh networking method, multicast is cancelled and replaced by a diffusion mode, and looping may be directly avoided. Meanwhile, the maximum number of devices in current networking is limited, and rapid convergence of the route updating and synchronizing method may be achieved.

Step S45, a reply and retransmission mechanism of the route management type network message is designed, the message body of the route management type network message contains serial number information to prevent interference of expired messages; and after the route management type message is received, reply is needed; and if no reply is received after the route management type message is transmitted, the route management type message is periodically retransmitted till the devices are determined to be offline or wired ports which are not connected are scanned.

Specifically, with reference to FIG. 6, a serial number may be a number added with 1 every time a route management message is transmitted, or a timestamp may be directly used as the serial number, which is synchronized between a transmitting side and a receiving side by a route management type network message, and if the device receives the route management type network message of an expired serial number, the route management type network message of the expired serial number is directly discarded.

Specifically, in order to prevent packet loss of the route management type message, after the device transmits the route management type network message, a timer may be started, if no reply to the route management message is received for more than 10 ms, the message needs to be retransmitted. The retransmission mechanism only aims at the latest route management type network message, and if the table of shortestHops[maxDevNum] of the device is updated before the device retransmits the message, the receiving side is only required to retransmit the latest message.

The reply mechanism of the route management type network message has various implementation modes, and the embodiment provides an extremely simple implementation mode. Referring to FIG. 5, the device 0 transmits a route management type network message to the device 1, and the device 1 will reply the message packet to the device 0 without change; when the device 0 receives the route management type network message, it can know that the message is a reply message (shortestHops[0]=1 of the device 1) from shortestHops[0]=0 in the message body, and a retransmission timer is stopped. By the mode, a new interaction message type does not need to be constructed, and the feature of lightweight is embodied.

Step S5, a forwarding and processing module for the lightweight wired Mesh network message is designed, and the step comprises:
S51, a field of target device ID in the message head of the lightweight wired Mesh network message is acquired, and is compared to a field of the own device ID;
S52, if the field of the target device ID is matched with the field of the own device ID, a service logic processing interface is called to process a message packet; if the field of the target device ID is not matched with the field of the own device ID, the hop table is searched according to the target device ID to obtain a network port corresponding to the optimal route, and the message is forwarded from the network port; and
S53, if obtaining of the port fails, route information is updated, a route updating message is transmitted to an adjacent port so as to recall a route table, and route information of all ports in the lightweight wired Mesh networking is corrected.

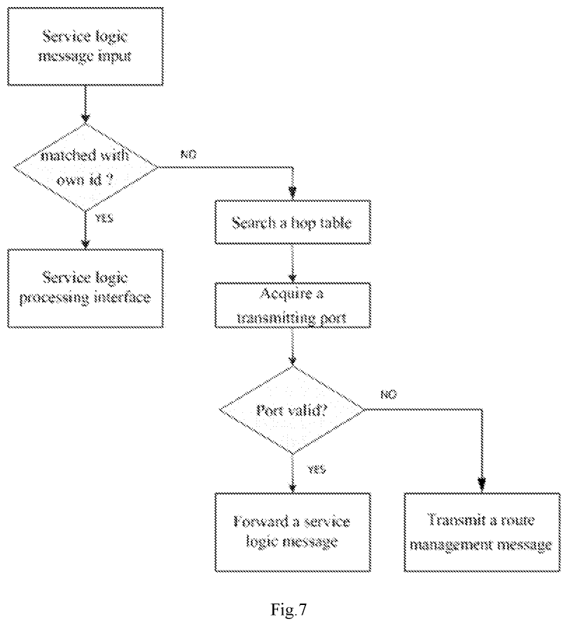

Specifically, when the message input parsing module in step S2 determines that the message is service logic message by means of the field of the message type in the message head, an interface of the forwarding and processing module for the wired Mesh network message is called, and the subsequent specific process flow refers to FIG. 7. After the service logic message is input, the field of the target device ID is extracted from the message head, and is compared with the field of the own device ID, if the comparison is successful, a service logic processing interface is called, and related service logic processing is carried out according to contents in the message body.

The service logic processing interface here may include some standard interfaces, such as modbus protocol control IO, and also includes a user defined interface. There are many ways to implement user customization. The simplest way is to directly open the header file and the source file to the user for self-development, and an interface may be provided for the user to register by referring to the way of a UDP client.

When the target device ID is not matched with the own device ID in the received service logic message, the message packet needs to be forwarded. The forwarding routing strategy is a recursive idea, and each time a message needs to be forwarded, the device selects a network port of an optimal route to transmit the message, so that the preamble path of the service logic message which reaches each node and needs to be forwarded may be regarded as optimal, and the device only needs to combine own shortestHops[maxDevNum] to hops[port][dstDevId] to select the optimal port, and then it may be ensured that the subsequent link is optimal. It should be noted that “optimal” here is measured in terms of the shortest hop.

If the obtained port is invalid, it indicates that a “broken route” occurs, and the route management module described in step S104 needs to be started to update and synchronize the route information and route state of the overall networking again. There are two criteria for “invalidation” of the port: 1) when the hop table is searched, the hop corresponding to the target device ID is larger than or equal to the current maximum value of the networking devices, and it indicates that the target device is not reachable; 2) after the hop table is searched, the obtained transmitting port is the same as the input port of the service logic message, which indicates that a forwarding loop exists. For any reason, a “broken route” is caused by asynchronous route information in networking, and therefore a route management function needs to be initiated to resynchronize route information.

Step S6, an underlying hardware interface management module is designed, and the step comprises the following substeps:
step S61, a required hardware interface management module is designed to provide a user with a registration function for a required hardware interface, wherein the required interface comprises a hardware initialization interface, a message transmitting interface, a message receiving interface and a connection state query interface.

Step S62, an optional hardware interface management module is designed to provide a user with a registration function for an optional hardware interface, wherein the optional hardware interface comprises a connection rate query interface, a hardware packet filtering configuration interface and a CRC verification configuration interface.

Specifically, a unified underlying hardware interface module is designed, so that other modules can directly call underlying hardware resources conveniently, and a middle packaging layer is reduced, thus, occupation of memory space is saved, and the feature of lightweight is highlighted. A standard underlying hardware interface management module is designed, transplanting on different platforms is facilitated, and the universality is greatly improved.

Management of the interface module is divided into management of the required interfaces and management of the optional interfaces, wherein the required interfaces have some functions necessary for achieving lightweight wired Mesh networking and comprise the hardware initialization interface, the message transmitting interface, the message interface and the connection state query interface. The hardware initialization interface needs information such as an access Mac address, a simplex-duplex working mode and rate configuration. The optional interfaces are related to some additional functions that are isolated by compiling macros.

The C language is used as a programming language to implement the present disclosure A plurality of specific implementation modes are provided for the hardware interface management module, and the simplest mode is to directly develop a header file and a source file for the user, define a standard hardware interface packaging format in the header file and realize specific contents of an interface by the user or a device manufacturer. Many intelligent home platforms implement standardization of an underlying hardware interface in the mode.

The specific embodiment of the method for the lightweight wired Mesh networking may meet two major features of Mesh networking: 1) Mesh networking is decentralized; and 2) all nodes are routes. Through a series of ingenious modes such as diffusion, backtracking and broadcast limitation, resource consumption of a complex routing algorithm is avoided, the networking flexibility is extremely high, and maintenance is facilitated. A networking condition of maximum 512 devices and maximum 4 ports of each device is adopted, the C language is used as a programming language, implementation of the whole method for the lightweight wired Mesh networking only needs about 1000 rows of codes for basic functions, the overall code amount does not exceed 10000 rows in consideration of various user specific scenes, code security and other aspects, occupation of memory data space during operation is less than 5K, and lightweight is truly achieved, so that low cost is achieved, and the networking may be implemented and transplanted in any common MCU/FPGA in the current market.

The foregoing is merely a preferred embodiment of the present disclosure and is not intended to limit the present disclosure, and any modifications, equivalents, improvements, or the like, which come within the spirit and principles of the present disclosure, are intended to be included within the scope of protection of the present disclosure.

What is claimed is:

1. A design method for lightweight wired Mesh networking, wherein the lightweight wired Mesh networking consists of a plurality of devices, each device is provided with a plurality of ports used for receiving or transmitting lightweight wired Mesh messages, the devices are connected to one another through the ports, and the design method comprises the following steps:
S1, designing a protocol format of a lightweight wired Mesh network message, wherein the lightweight wired Mesh network message comprises a message head and a message body;
S2, designing an input parsing module of the lightweight wired Mesh network message, wherein the input parsing module is used for inputting the received lightweight wired Mesh network message, acquiring a field of a message type in the message head of the lightweight wired Mesh network message, and calling a different manipulation function to process the lightweight wired Mesh network message according to the value of the field;
S3, designing a heartbeat logic module between the devices of the lightweight wired Mesh networking;
S4, designing a route management module of networks in the lightweight wired Mesh networking;
S5, designing a forwarding and processing module of the lightweight wired Mesh network message; and
S6, designing an underlying hardware interface management module.

2. The design method for the lightweight wired Mesh networking according to claim 1, wherein the specific design of step S1 is as follows: the length of the message head is 14 bytes, and the values of the first 6 bytes of the message head are all fixed 0xff; the 7th byte and the 8th byte of the message head are respectively high 8 bits and low 8 bits of target device ID; the 9th byte and the 10th byte of the message head are respectively high 8 bits and low 8 bits of the overall length of the lightweight wired Mesh network message; the 11th byte and the 12th byte of the message head are high 8 bits and low 8 bits of the maximum forwarding number of the lightweight wired Mesh network message; and the 13th byte and the 14th byte of the message head are high 8 bits and low 8 bits of the message type.

3. The design method for the lightweight wired Mesh networking according to claim 1, wherein the message type in step S2 includes, but is not limited to, a heartbeat type network message, a route management type network message and a user service message, and the manipulation function includes, but is not limited to, a heartbeat type network message manipulation function, a route management type network message manipulation function and a service message manipulation function.

4. The design method for the lightweight wired Mesh networking according to claim 1, wherein step S3 comprises the following substeps:
S31, designing a configuration interface, wherein the configuration interface is used for configuring heartbeat circulation time and a heartbeat time-out period;
S32, designing a transmitting and receiving mechanism of the heartbeat type network message, wherein transmitting and receiving of the heartbeat type network message is only maintained between devices directly connected by ports, and the devices indirectly connected by ports of an intermediate device do not receive the heartbeat type network message transmitted from each other; and
S33, designing a transmitting heartbeat time-out table and a receiving heartbeat time-out table, wherein the transmitting heartbeat time-out table is used for recording the time of transmitting the heartbeat type network message to the adjacent port last time, and if the time exceeds configured heartbeat circulation time, the heartbeat type network message needs to be transmitted again; and the receiving heartbeat time-out table is used for recording the time of receiving the heartbeat type network message of the adjacent port last time, and if the time exceeds configured heartbeat time-out period, the device of the adjacent port is determined to be offline.

5. The design method for the lightweight wired Mesh networking according to claim 4, wherein a mode of designing the configuration interface in step S31 is one of the following modes:
S311, using a configuration file as an interface by a user;
S312, designing a special configuration interface and transmitting configuration data into the designed special configuration interface by the user; and
S313, defaulting that the heartbeat circulation time is 2 s, and the heartbeat time-out period is 1 min.

6. The design method for the lightweight wired Mesh networking according to claim 1, wherein step S4 comprises the following substeps:
S41, designing a configuration interface, wherein the maximum number of devices in the current lightweight wired Mesh networking is selected, and the selection is one of four numbers of 128, 256, 512 and 1024;
S42, designing a hop table, relative to the target device ID, of the port, wherein the number of the hop tables is the same as the number of wired network ports of the devices, and the length of each hop table is equal to the maximum number of networking devices configured by the user; and the hop table is used for recording the hop, relative to each device, of each port;
S43, designing a second hop table, relative to the target device ID, of the device, wherein the second hop table is used for recording the minimum hop, relative to the target device, of the current device, and the length of the second hop table is equal to the maximum number of devices in the current networking configured by the user;
S44, designing a transmitting and receiving mechanism of the route management type network message, wherein the route management type network message is only transmitted and received between the devices directly connected by the ports, and the devices indirectly connected by ports of an intermediate device do not receive the route management type network message transmitted from each other; and
S45, designing a reply and retransmission mechanism of the route management type network message, wherein the devices need to reply after receiving the route management type message; and if no reply is received after the devices transmit the route management type message, the devices periodically re-transmit the route management type message till the devices are determined to be offline or the ports are scanned to be not connected, and route information is updated.

7. The design method for the lightweight wired Mesh networking according to claim 6, wherein a mode of designing a configuration interface in step S41 is one of the following modes:
S411, using a configuration file as an interface by a user;
S412, designing a special configuration interface and transmitting configuration data into the designed special configuration interface by the user; and
S413, defaulting that the maximum number of devices is 256.

8. The design method for the lightweight wired Mesh networking according to claim 6, wherein step S5 comprises the following steps:
S51, acquiring a field of the target device ID in the message head of the lightweight wired Mesh network message, and comparing the field of the target device ID to a field of an own device ID;
S52, if the field of the target device ID is matched with the field of the own device ID, calling a service logic processing interface to process the lightweight wired Mesh network message; if the field of the target device ID is not matched with the field of the own device ID, searching the hop table according to the target device ID to obtain a port corresponding to the shortest hop, and forwarding the message from the port, wherein the service logic processing interface comprises a standard interface and a user defined interface; and
S53, if obtaining of the port fails, updating route information, transmitting a route updating message to an adjacent port so as to recall a route table, and correcting route information of all ports in the lightweight wired Mesh networking.

9. The design method for the lightweight wired Mesh networking according to claim 6, wherein step S6 comprises the following substeps:
step S61, designing a required hardware interface management module to provide a user with a registration function for a required hardware interface, wherein the required hardware interface comprises a hardware initialization interface, a message transmitting interface, a message receiving interface and a connection state query interface; and
step S62, designing an optional hardware interface management module to provide a user with a registration function for an optional hardware interface, wherein the optional hardware interface comprises a connection rate query interface, a hardware packet filtering configuration interface and a CRC verification configuration interface.
